(19) United States
(12) Patent Application Publication
(10) Pub. No.: US 2010/0045755 A1
(43) Pub. Date: Feb. 25, 2010

(54) LIQUID CONTAINER, LIQUID CONTAINER MOUNTING AND DETACHING STRUCTURE, AND LIQUID EJECTION APPARATUS

(75) Inventor: Satoshi KOBAYASHI, Kitakyushu-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/545,631

(22) Filed: Aug. 21, 2009

(30) Foreign Application Priority Data
Aug. 22, 2008 (JP) 2008-214195

(51) Int. Cl. B41J 2/175

(52) U.S. Cl. 347/86

(57) ABSTRACT

A liquid container mounting and detaching structure in which a liquid container containing liquid can be mounted and detached, and upon mounting the liquid container, a liquid discharge member having an opening at its tip is inserted through a liquid discharge opening provided in the liquid container to discharge the liquid, and the liquid discharged from the inside of the liquid container is caused to flow into a liquid passage connected to the liquid discharge member through the opening of the liquid discharge member.

### BACKGROUND

1. Technical Field

The present invention relates to a liquid container such as an ink cartridge, a mounting and detaching structure of the liquid container, and a liquid ejection apparatus having the mounting and detaching structure, such as an ink jet type printing apparatus.

2. Related Art

In the past, as a kind of liquid ejection apparatus for ejecting liquid towards a target from a liquid ejection head, an ink jet type printing apparatus (hereinafter, referred to as a “printer”) is widely known. In a type of printer that supplies ink to a liquid ejection head through an ink passage from an ink cartridge containing ink, a cartridge holder which allows the mounting and detaching of the ink cartridge is provided. In addition, the cartridge holder inserts an ink supplying needle through an ink discharge opening of the ink cartridge to discharge the ink stored in the ink cartridge to be introduced into the ink passage connected to the liquid ejection head.

However, in the cartridge holder, for example, in the case where the ink cartridge is detached for a long time the volume of ink decreases as the ink evaporates from the ink supplying needle, so that the ink surface at the opening of the ink supplying needle is lowered by the decreased volume amount, thereby forming a concave ink surface. In addition, when the ink cartridge is mounted to the cartridge holder in this state, there is a danger that there is trapped air in the concave surface of the opening of the ink supplying needle and the bubbles are incorporated in the ink passage.

Therefore, in the printer disclosed in JP-A-2002-154217, a part of a wall of an ink passage is made of an elastic member, and a protrusion is provided to an elastic piece supported by a housing of an ink cartridge in a cantilever shape. Upon mounting the ink cartridge, the protrusion comes in pressing contact with the elastic member of the ink cartridge, the elastic member is deformed towards the inside of the ink passage, the ink pressure in the ink supplying passage is increased due to the incorporation of the elastic member, and the ink surface at the opening of the ink supplying needle then becomes concave.

However, in the ink jet printing apparatus disclosed in JP-A-2002-154217, as the pressing degree of the protrusion towards the elastic member increases upon mounting, the elastic piece supporting the protrusion on the ink cartridge side receives a reaction force from the elastic member which causes it to be pushed back and bent in a direction away from the elastic member. It is released from its bent state at a time point when the mounting of the ink cartridge is completed, and the elastic piece is restored to its original shape.

Accordingly, in this configuration in the state where the mounting of the ink cartridge is completed, the elastic member is pressed by such a degree in a direction that the volume in the ink passage is decreased by the protrusion from the elastic piece. Therefore, upon detaching the ink cartridge, the state where the elastic member is pressed by the protrusion is released to restore the elastic member, the ink pressure in the ink passage is decreased as the volume in the ink passage is increased, and there still is a possibility that bubbles are incorporated into the ink passage.

### SUMMARY

An advantage of some aspects of the invention is that it provides a liquid container, a liquid container mounting and detaching structure, and a liquid ejection apparatus having the mounting and detaching structure, which can avoid the incorporation of bubbles into a liquid passage connected to the liquid container to discharge liquid upon mounting and detaching the liquid container.

According to an aspect of the invention, there is provided a liquid container mounting and detaching structure in which a liquid container containing liquid can be mounted and detached, and upon mounting the liquid container, a liquid discharge member having an opening at its tip is inserted through a liquid discharge opening provided in the liquid container to discharge the liquid, and the liquid discharged from the inside of the liquid container is caused to flow into a liquid passage connected to the liquid discharge member through the opening of the liquid discharge member, including: a passage formation unit that constitutes at least a part of the walls in the liquid passage so as to be displaced in a direction to increase or decrease the volume in the liquid passage; a first biasing mechanism that biases the passage formation unit in the direction to increase the volume in the liquid passage; a pressing member that presses the passage formation unit in the direction to decrease the volume in the liquid passage against the biasing force of the first biasing mechanism upon mounting the liquid container; and a second biasing mechanism that biases the pressing member in a pressing direction, wherein the biasing force of the second biasing mechanism is set to be greater than the biasing force of the first biasing mechanism upon mounting the liquid container, and set to be smaller than the biasing force of the first biasing mechanism upon detaching the liquid container from the mounted state.

With such a configuration, upon mounting the liquid container, the biasing force of the second biasing mechanism for biasing the pressing member is set to be greater than the biasing force of the first biasing mechanism for biasing the passage formation unit. Accordingly, the pressing member can press the passage formation unit against the biasing force of the first biasing mechanism in the direction to decrease the volume in the liquid passage while coming in contact with the passage formation unit. Therefore, as the volume in the liquid passage is decreased, the liquid pressure in the liquid passage is increased, so that the liquid surface at the opening of the liquid discharge member connected to the liquid passage becomes convex. In addition, in the case where air between the liquid surface at the opening and the liquid surface of the liquid container is trapped in that state, it is possible to avoid the incorporation of the air into the liquid container as bubbles.

On the other hand, upon detaching the liquid container, the biasing force of the second biasing mechanism toward the pressing member is set to be smaller than the biasing force of the first biasing mechanism toward the passage formation unit. Accordingly, the passage formation unit can increase the volume in the liquid passage against the biasing force of the second biasing mechanism while coming in contact with the pressing member biased by the second biasing mechanism. That is, at the time point when the liquid container is detached from the mounting state and the opening of the liquid discharge member is exposed to the air, the passage formation unit is restored to the state before the liquid container was mounted. Accordingly, at the time point when the liquid container is to be detached, the volume in the liquid passage increases as compared with the time point when the mounting of the liquid container is completed, and the liquid pressure in the liquid passage is decreased, so that air does not move into the liquid passage. Therefore, upon mounting and detaching the liquid container, it is possible to avoid the incorporation of bubbles into the liquid passage connected to the liquid container to discharge the liquid.

In the liquid container mounting and detaching structure, the second biasing mechanism includes: an air chamber that slidably supports the pressing member in the pressing direction in the state where the base end portion of the pressing member in the pressing direction is inserted, and of which the volume is changed as the pressing member is moved along the pressing direction; a press-side elastic member that is provided in the air chamber and comes in contact with the base end portion of the pressing member in the pressing direction for biasing the pressing member in the pressing direction; and an air throttle passage that is provided at a position deviating from the movement range of the pressing member in the air chamber to enable communication with the outside, and that allows the air to flow between the inside and the outside of the air chamber while the air flow is throttled as the volume in the air chamber is increased or decreased with the movement of the pressing member. The air throttle passage restricts the air flow from the air chamber such that the sum of the biasing force of the press-side elastic member toward the pressing member and the biasing force of the air in the air chamber toward the pressing member is greater than the biasing force of the first biasing mechanism toward the passage formation unit upon mounting the liquid container, and allows the air flow from the air chamber such that the sum of the biasing force of the press-side elastic member toward the pressing member and the biasing force of the air in the air chamber toward the pressing member is smaller than the biasing force of the first biasing mechanism toward the passage formation unit when the mounting of the liquid container is completed.

With such a configuration, upon mounting the liquid container, the passage formation unit pushes the pressing member back against the biasing force of the press-side elastic member. Here, the air in the air chamber is compressed without being rapidly released from the air throttle passage to increase the pressure and biases the pressing member toward the passage formation unit along with the press-side elastic member. As a result, the second biasing member can press the passage formation unit in the direction to decrease the volume in the liquid passage against the biasing force of the first biasing mechanism.

When the mounting of the liquid container is completed, the air in the air chamber slowly leaks through the air throttle passage such that the pressure gradually decreases. In addition, at a time point when the biasing force of the second biasing mechanism is lower than the biasing force of the first biasing mechanism, the passage formation unit biased by the first biasing mechanism pushes the pressing member back against the biasing force of the second biasing mechanism to be restored to the state before the mounting of the liquid container. Therefore, the configuration in which the magnitude relationship between the biasing forces is changed according to the mounting and detaching of the liquid container can be easily implemented.

In the liquid container mounting and detaching structure, the first biasing mechanism includes a counter press-side elastic member that comes in contact with the passage formation unit from the inside of the liquid passage and biases the passage formation unit against the biasing force of the second biasing mechanism, in a direction to increase the volume in the liquid passage, which is the opposite direction to the pressing direction of the pressing member, and the elastic force of the counter press-side elastic member is designed to be greater than the elastic force of the press-side elastic member.

With such a configuration, when the mounting of the liquid container is completed, the pressure of the air in the air chamber compressed by the pressing member is decreased to a degree substantially equal to the external pressure, so that the biasing force of the air in the air chamber towards the pressing member is released. As a result, the liquid formation unit can push the pressing member back in the opposite direction to the pressing direction against the biasing force of the press-side elastic member. That is, when the mounting of the liquid container is completed the configuration is such that the biasing force of the first biasing mechanism is greater than the biasing force of the second biasing mechanism.

The liquid container mounting and detaching structure further includes a displacement member that displaces while in contact with the liquid container, and the pressing member is provided in the displacement member and displaces between a contact position and a separated position to and from the passage formation unit upon mounting and detaching the liquid container.

With such a configuration, it is not necessary to provide the pressing member in the liquid container, so that it is possible to increase the design freedom of the liquid container.

In addition, the liquid ejection apparatus according to the embodiment of the invention includes a liquid ejection head for ejecting liquid and the liquid container mounting and detaching structure having the above-mentioned configuration. In this configuration, the same advantages as those of the liquid container mounting and detaching structure can be obtained.

According to another aspect of the invention, there is provided a liquid container which can be mounted and detached from a liquid container holder that includes a liquid discharge member having an opening at its tip, a passage formation unit that constitutes at least a part of walls in the liquid passage connected to the liquid discharge member so as to be displaced in a direction to increase or decrease the volume in the liquid passage; and a first biasing mechanism for biasing the passage formation unit in the direction to increase the volume in the liquid passage, that contains liquid, and that has a liquid discharge opening through which the liquid discharge member is inserted to discharge the liquid upon mounting the liquid container to the liquid container holder, including: a pressing member that presses the passage formation unit in the direction to decrease the volume in the liquid passage against the biasing force of the first biasing mechanism upon mounting the liquid container to the liquid container holder; and a second biasing mechanism that biases the pressing member in a pressing direction, wherein the biasing force of the second biasing mechanism is set to be greater than the biasing force of the first biasing mechanism upon mounting the liquid container to the liquid container holder and set to be smaller than the biasing force of the first biasing mechanism upon detaching the liquid container from the state mounted to the liquid container holder.

With such a configuration, the liquid container which can be suitably mounted and detached to and from the liquid container mounting and detaching structure and the liquid ejection apparatus having the mounting and detaching structure.

### BRIEF DESCRIPTION OF THE DRAWINGS

The invention will be described with reference to the accompanying drawings, wherein like numbers reference like elements.

FIG. 1 is a schematic view illustrating the configuration of a printer according to a first embodiment.

FIG. 2 is a perspective view illustrating a cartridge and a holder according to the first embodiment.

FIG. 3 is a partially exploded perspective view illustrating the cartridge according to the first embodiment.

FIG. 4 is a schematic explanatory view illustrating a mounting and detaching structure of the cartridge according to the first embodiment.

FIG. 5A is a schematic explanatory view illustrating a position relationship between a film member and a sliding member when mounting of the cartridge is started, and FIG. 5B is a schematic explanatory view illustrating a position relationship between a supplying needle and a supplying opening when the mounting of the cartridge is started.

FIG. 6A is a schematic explanatory view illustrating a position relationship between the film member and the sliding member upon mounting the cartridge, and FIG. 6B is a schematic explanatory view illustrating a position relationship between the supplying needle and the supplying opening upon mounting the cartridge.

FIG. 7A is a schematic explanatory view illustrating a position relationship between the film member and the sliding member right before the mounting of the cartridge is completed, and FIG. 7B is a schematic explanatory view illustrating a position relationship between the supplying needle and the supplying opening right before the mounting of the cartridge is completed.

FIG. 8A is a schematic explanatory view illustrating a position relationship between the film member and the sliding member right before the mounting of the cartridge is completed, and FIG. 8B is a schematic explanatory view illustrating a position relationship between the supplying needle and the supplying opening right before the mounting of the cartridge is completed.

FIG. 9A is a schematic explanatory view illustrating a position relationship between the film member and the sliding member after the mounting of the cartridge is completed, and FIG. 9B is a schematic explanatory view illustrating a position relationship between the supplying needle and the supplying opening after the mounting of the cartridge is completed.

FIG. 10A is a schematic explanatory view illustrating a position relationship between the supplying needle and the supplying opening when detaching of the cartridge is started, FIG. 10B is a schematic explanatory view illustrating a position relationship between the supplying needle and the supplying opening upon detaching the cartridge, and FIG. 10C is a schematic explanatory view illustrating a position relationship between the supplying needle and the supplying opening right after the cartridge is detached.

FIG. 11 is a perspective view illustrating a cartridge and a holder according to a second embodiment.

FIG. 12A is a schematic explanatory view illustrating a position relationship between the cartridge and the holder upon mounting the cartridge, and FIG. 12B is a schematic explanatory view illustrating a position relationship between the cartridge and the holder after the mounting of the cartridge is completed.

### DESCRIPTION OF EXEMPLARY EMBODIMENTS

### First Embodiment

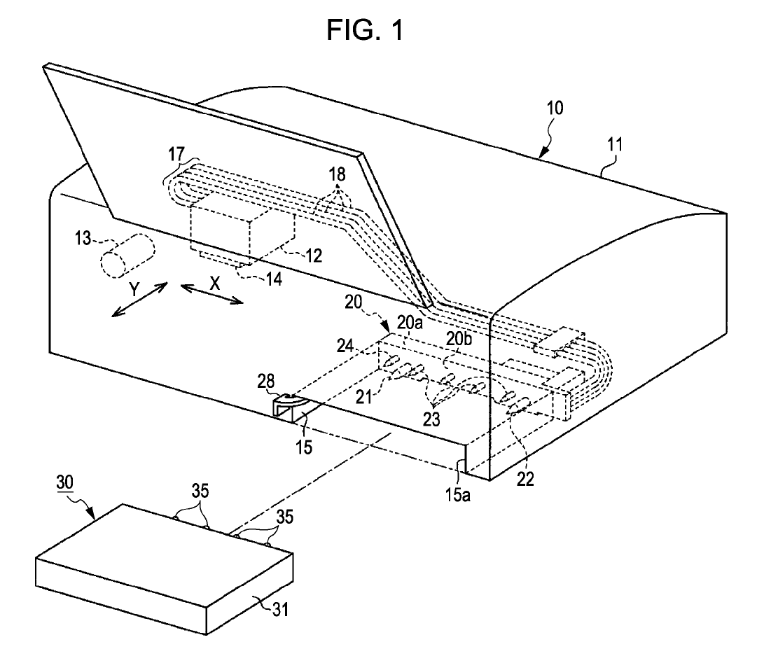

Hereinafter, a first embodiment that embodies the invention will be described with reference to FIGS. 1 to 10.

As illustrated in FIG. 1, an ink jet type printing apparatus (hereinafter, referred to as a “printer 10”) as a liquid ejection apparatus has a main body case 11 formed substantially in a box shape. In the main body case 11, a carriage 12 is provided to be movable along a guide shaft (not shown) installed between a pair of left and right side plates. The carriage 12 reciprocates in a main scanning direction X along the guide shaft by a driving force of a carriage motor 13.

A print head 14 as a liquid ejection head is provided under the bottom surface of the carriage 12, and a plurality of ejection nozzles (not shown) for discharging inks as liquid is provided in the print head 14. The carriage 12 includes sub tanks (not shown) and a valve unit (not shown) for supplying pressure-adjusted ink to the print head 14 to supply pressure-adjusted inks of four colors (black, yellow, magenta, and cyan) to the print head 14.

A platen (not shown) having a rectangular plate shape to be parallel to the main scanning direction X is disposed below a space where the carriage 12 moves in the main body case 11, and a printing sheet that is fed is passed on the platen and transported in a sub-scanning direction Y perpendicular to the main scanning direction X. In addition, by alternately performing scanning of the carriage 12 which moves in the main scanning direction while discharging ink droplets through the nozzles of the print head 14 and transportation of the printing sheet in the sub-scanning direction Y by a predetermined distance, the printing sheet is printed.

At a lower portion on the rear side of the main body case 11, a cartridge accommodating part (hereinafter, referred to as an “accommodating part 15”) is recessed. In addition, in the main body case 11, inside the accommodating part 15, a cartridge holder (hereinafter, referred to as a “holder 20”) as a liquid container holder is disposed. An ink cartridge (hereinafter, referred to as a “cartridge 30”) as a liquid container is inserted through an accommodation opening 15a and mounted to the holder 20. A lever handle 28 is provided on one side of the accommodation opening 15a in the accommodating part 15. In addition, upon mounting the cartridge 30, the lever handle 28 is turned to push the cartridge 30 into the accommodating part 15 with a relatively light operating force through a deceleration mechanism (not shown) such that a supplying needle 23 on the side of the holder 20 is inserted into the cartridge 30. The cartridge 30 mounted in the accommodating part 15 is locked at a mounting position by a locking mechanism not shown.

In the main body case 11, the holder 20 and the carriage 12 are connected via four supplying passages 18 made of a flexible material, which are collected as a belt-like passage cluster 17. Ink of each color is supplied to the corresponding sub tank (not shown) in the carriage 12 through the supplying passage 18 from the cartridge 30 mounted to the holder 20.

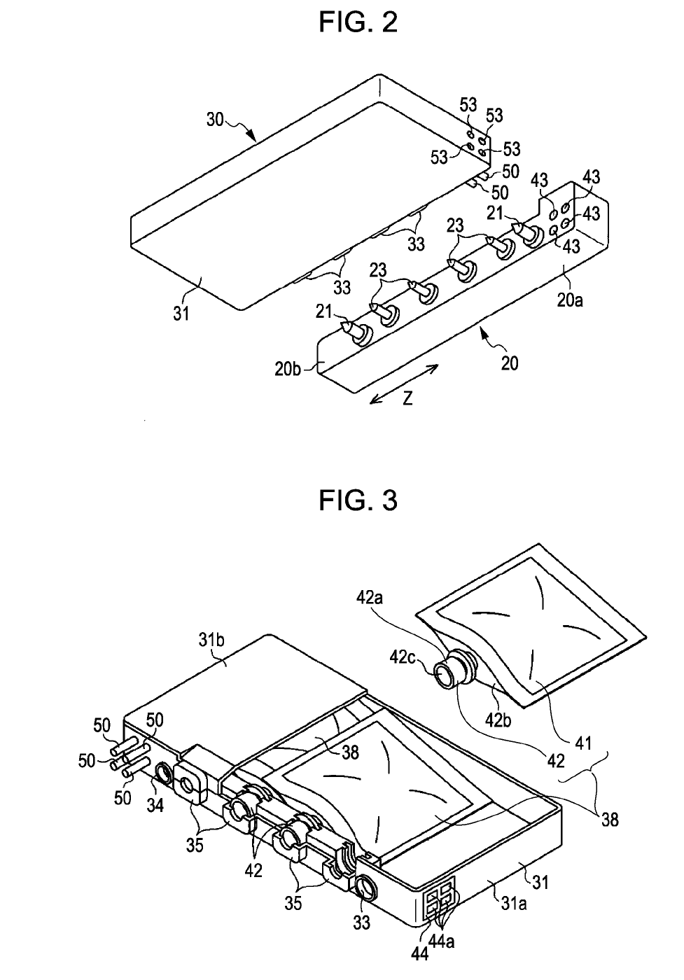

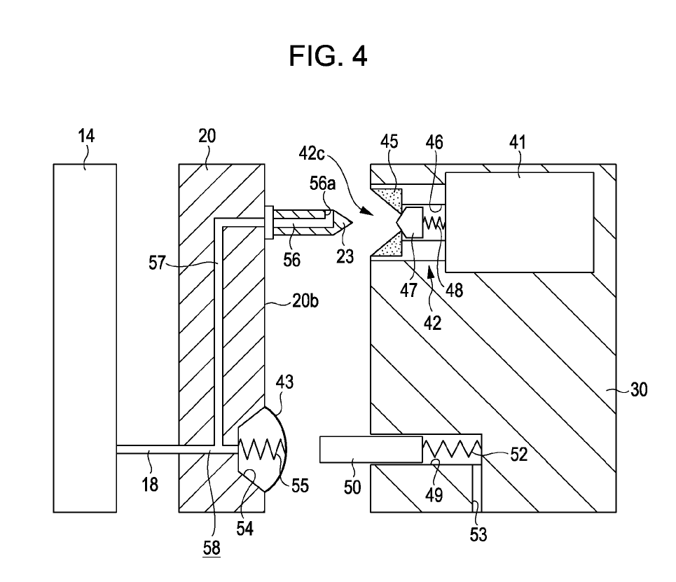

As illustrated in FIGS. 1 and 2, the holder 20 includes a holder main body 20a having a substantially rectangular plate shape with substantially the same transverse width (X direction width) as that of the cartridge 30. The surface of the holder main body 20a which is opposed to the accommodation opening 15a is a connecting surface 20b to be connected to the cartridge 30. In addition, the connecting surface 20b of the holder 20 is provided with a pair of position determination protrusions 21 and 22 disposed at both end portions in the longitudinal direction thereof and plural (in this embodiment, four) ink supplying needles (hereinafter, referred to as the “supplying needles 23”) which protrude and are disposed at equal intervals as liquid discharge members. In addition, in the vicinity on the outside of one of the position determination protrusions 21, plural (in this embodiment, four) circular concave portions 54 (see FIG. 4) are formed, and each concave portion 54 is sealed up by a film member 43 as a passage formation unit.

A circuit board 44 having a connection terminal 44a on its surface is attached to a side wall of the accommodating case 31 of the cartridge 30. The connection terminal 44a is electrically connected to a semiconductor storage (not shown) which can read and write data implemented in the circuit board 44. The semiconductor storage stores data such as a type of ink, a remaining amount of ink, a serial number, an expiration data, and the like on each ink pack 38 (see FIG. 3) accommodated in the accommodating case 31. In addition, in the state where the cartridge 30 is mounted to the holder 20, the connection terminal of the circuit board is connected to a terminal (not shown) provided on the holder side so that a controller (not shown) of the printer 10 can read and write data such as the remaining amount of ink on the semiconductor storage of the cartridge 30.

As illustrated in FIG. 3, a pair of position determination holes 33 and 34 are formed on a front surface (a mounting surface) of the cartridge 30 at positions corresponding to the pair of position determination protrusions 21 and 22 of the holder 20. In addition, supporting holes 35 are formed on the front surface of the cartridge 30 at positions corresponding to the plural supplying needles 23 of the holder 20. When the cartridge 30 is mounted to the holder 20, the position determination protrusions 21 and 22 are intruded into the position determination holes 33 and 34, respectively, such that the movement of the cartridge 30 in a direction crossing the mounting direction (Y direction in FIG. 1) is restricted for position determination. Then, the supplying needles 23 are intruded into the respective supporting holes 35 in the state of position determination to be connected to the holder 20.

Plural ink packs 38 are accommodated in the accommodating case 31 configured by a case main body 31a and a cover 31b. The ink pack 38 includes a pouch 41 and an ink discharge opening forming member 42 which is fixed to an end portion of the pouch 41 to protrude outward therefrom. The pouch 41 is made of a flexible material and for enhancing gas barrier properties, formed as an aluminum laminate film constituted by bonding together a nylon film on the outside and a polyethylene film on the inside. In addition, the pouch 41 formed by allowing the two aluminum laminate films having a substantially rectangular shape to overlap with each other and performing thermal lamination on the peripheries thereof to be adhered to each other, is fixed to a base portion 42b of the ink discharge opening forming member 42 to store ink.

The ink discharge opening forming member 42 includes the hull-shaped base portion 42b of which the width decreases toward the both ends in plan view (in a direction from the supporting hole 35), and a supplying portion 42a which has a substantially cylindrical shape protruding from the base portion 42b, which are formed integrally with each other. The aluminum laminate films of the pouch 41 are bonded to side peripheral surfaces of the base portion 42b by thermal compression. The inside of the ink discharge opening forming member 42 forms an ink supplying opening (hereinafter, referred to as a “supplying opening 42c”) as a liquid discharge opening, and through the supplying opening 42c, ink accommodated in the ink pack 38 is discharged.

As illustrated in FIGS. 3 and 4, the ink discharge opening forming member 42 is made of elastomer for allowing the supplying needles 23 of the holder 20 to be intruded into the supplying opening 42c, and includes a seal member which has an annular shape having a circular opening substantially with the same diameter as the outer diameter of the supplying needle 23, a valve chamber 46 provided between the seal member 45 and the pouch 41 as a compartment, a supplying valve 47 seated on the seal member in the valve chamber 46, and a coil spring 48 for biasing the supplying valve 47 toward the seal member 45. In addition, the supplying opening 42c is always in a closed state when the supplying valve 47 biased by the coil spring comes in pressing contact with the seal member 45 and the flow of ink from the cartridge 30 through the opening of the seal member 45 is restricted. On the other hand, when the supplying needle 23 of the holder 20 is intruded into the supplying opening 42c, the supplying valve 47 is pressed by the supplying needle 23 and moved toward the inner rear side from the supplying opening 42c to be separated from the seal member 45 against the biasing force of the coil spring 48, and the supplying opening 42c is in an opened state for allowing the flow of the ink from the cartridge 30 through the opening of the seal member 45.

As illustrated in FIGS. 2 and 4, a concave portion 49 having a substantially cylindrical shape is recessed to form an air chamber on the front surface of the cartridge 30 at a position corresponding to each film member 43 of the holder 20. In addition, a sliding member 50 having a substantially columnar shape with substantially the same cross-section as that of the concave portion 49 is inserted into and fitted to each concave portion 49 to protrude toward the holder 20. The sliding member 50 slides along the inner peripheral surface of the concave portion 49 and displaces so as to increase or decrease the volume in concave portion 49 while sealing. In addition, upon mounting the cartridge 30, the sliding member 50 exerts a pressing force on the film member 43. That is, upon mounting the cartridge 30, the sliding member 50 functions as a pressing member for pressing the film member 43 in a direction to decrease the volume of the supplying passage 18.

In addition, a coil spring 52 as a press-side elastic member is accommodated in each concave portion 49 between the inner rear surface of the concave portion 49 and the base end portion of the sliding member 50 to configure a second biasing mechanism. The coil spring 52 biases the sliding member 50 toward the pressing direction (the side of the film member 43) such that the front end portion of the sliding member 50 always protrudes forward from the front surface of the cartridge 30.

Communicating holes 53 as plural air throttle passages for allowing the concave portions 49 to communicate with the outside penetrate a side wall of the cartridge 30. The communicating hole 53 has a small cross-section such that in the case where the volume in the concave portion 49 is changed with the movement of the sliding member 50, air can flow between the inside of the concave portion 49 and the outside while the air flow is throttled. Accordingly, in the case where the sliding member 50 is moved in a direction (a direction to be immersed in the concave portion 49) counter to the pressing direction, it is restricted since the flow of air to the outside from the concave portion 49 through the communicating hole 53 is throttled. As a result, air in the concave portion 49 is compressed, and the air pressure biases the sliding member 50 toward the pressing direction (a direction so as to protrude from the concave portion 49) along with the coil spring 52. Therefore, in this embodiment, the communicating hole 53, the concave portion 49 provided with the communicating hole 53, and the coil spring 52 provided in the concave portion 49 constitute the second biasing mechanism for biasing the sliding member 50 in the pressing direction.

The plural (in this embodiment, four) concave portions 54 connected to the introducing passages 56 (see FIG. 4) provided in the supplying needles 23 and to plural (in this embodiment, four) respective supplying passages 57 (see FIG. 4) provided in the holder 20 to be individually connected to the respective supplying passages 18, are recessed on the connecting surface 20b of the holder 20 at positions opposed to the respective sliding members 50 of the cartridge 30 in the mounting direction of the cartridge 30. In addition, the film member 43 having a thin film shape made of a flexible material is attached to the connecting surface 20b of the holder 20 to cover the opening of each concave portion 54. In the concave portion 54, a coil spring 55 as a counter press-side elastic member which comes in contact with the film member 43 from the inside of the concave portion 54 for biasing the film member 43 in a direction (the side of the cartridge 30) to increase the volume in the concave portion 54 is accommodated to configure a first biasing mechanism.

The introducing passage 56 having an opening 56a on a side surface of the tip of the supplying needle 23 is provided in each supplying needle 23, and the introducing passages 56 are connected to the plural respective supplying passages 57 provided in the holder 20. The supplying passage 57 is bifurcated from a base end on the side of the supplying needle 23 such that one end side thereof is connected to the concave portion 54 of the holder 20 and the other end side is connected to the sub tank in the print head 14 through the supplying passage 18. That is, in this embodiment, the introducing passage 56, the supplying passage 57, the concave portion 54, and the supplying passage 18 constitute an ink passage 58 as a liquid passage for supplying ink introduced from the cartridge 30 to the print head 14.

Next, operations of the printer 10 having the above-mentioned configuration, and more particularly, operations of the holder 20 upon mounting the cartridge 30 will be described.

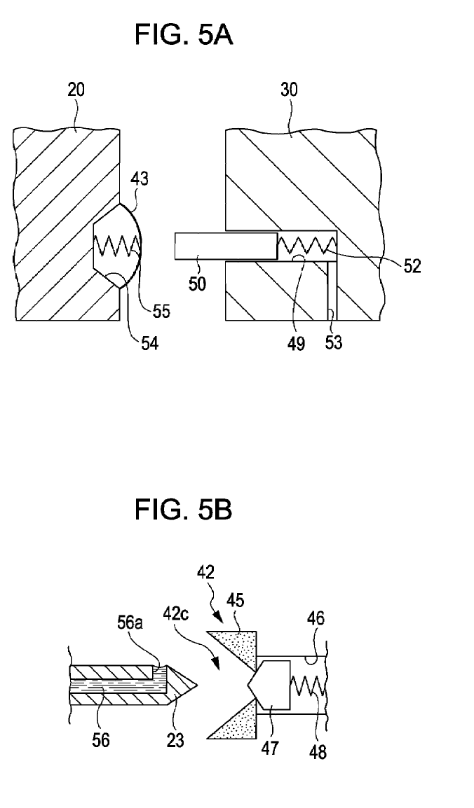

First, upon mounting the cartridge 30 to the holder 20, the cartridge 30 is inserted through the accommodation opening 15a of the accommodating part 15 in the main body case 11. Here, as illustrated in FIG. 5A, there is a distance between the sliding member 50 of the cartridge 30 and the film member 43 of the holder 20 in the mounting direction of the cartridge 30. Simultaneously, as illustrated in FIG. 5B, there is also a distance between the supplying valve 47 of the cartridge 30 and the supplying needle 23 of the holder 20. In FIGS. 5A and 5B, a state where the cartridge 30 is detached from the holder 20 for a long time is shown. In the supplying needle 23, the volume of the ink decreases as the ink in the introducing passage 56 evaporates from the opening 56a into the air, so that an ink surface at the opening 56a of the supplying needle 23 is lowered by the decreased volume amount and forms a concave ink surface.

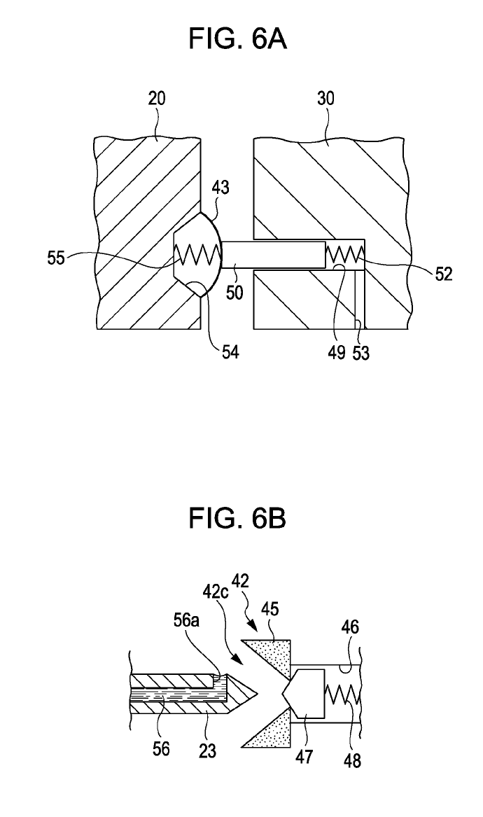

Then, as illustrated in FIG. 6A, when the cartridge 30 is pushed to a position slightly past a position at which the sliding member 50 and the film member 43 come in contact with each other, since the elastic force of the coil spring 52 for biasing the sliding member 50 in the pressing direction is set to be smaller than the elastic force of the coil spring 55 which is in contact with the film member 43 for biasing, the sliding member 50 slides while coming in close contact with the inner peripheral surface of the concave portion 49 to be inserted into the concave portion 49. Here, as the volume in the concave portion 49 is reduced only by the displacement of the sliding member 50 while the concave portion 49 is sealed by the sliding member 50, the pressure increases, and the biasing force for pressing the sliding member 50 toward the holder 20 increases. As a result, the biasing force of the coil spring 55 toward the film member 43 becomes the same as the sum of the biasing force of the coil spring 52 toward the sliding member 50 and the biasing force of the air pressure in the concave portion 49 sealed by the sliding member 50 toward the sliding member 50.

The communicating hole 53 for communication between the inside and the outside of the concave portion 49 is designed to serve as a passage resistance for preventing the air in the concave portion 49 from instantly leaking in the case where the pressure in the concave portion 49 increases. The film member 43 is biased outward by the coil spring 55 and presses the sliding member 50 against the biasing force of the coil spring 52 without being bent inward. Accordingly, the volume in the concave portion 54 sealed by the film member 43 is not changed, and the pressure of ink accommodated in the concave portion 54 becomes constant. Consequently, the pressure of the ink in the introducing passage 56 connected to the concave portion 54 also becomes constant, so that the ink surface at the opening 56a of the supplying needle 23 maintains its concave shape (see FIG. 6B).

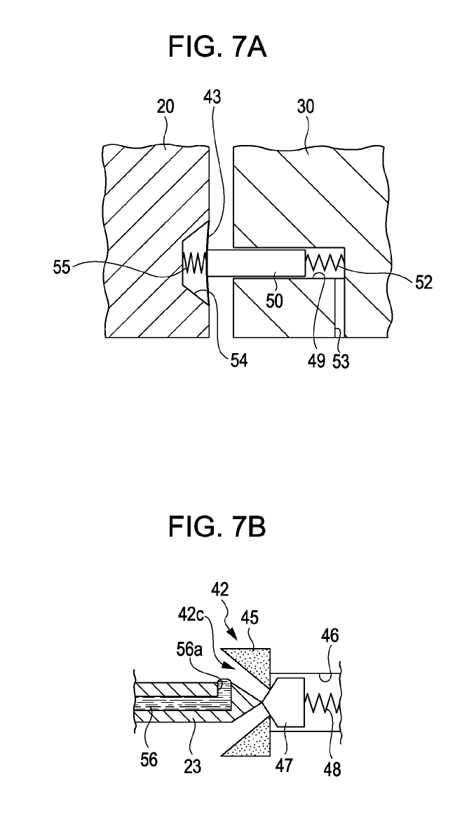

As illustrated in FIG. 7A, when the cartridge 30 is pushed to a position at which the sliding member 50 and the film member 43 are closer to each other, as the biasing force of the coil spring 55 toward the film member 43 and the biasing force of the coil spring 52 and the air pressure in the concave portion 49 towards the sliding member 50 maintain a balanced state, the sliding member 50 deforms the film member 43 to be bent in a direction to decrease the volume in the concave portion 54, against the biasing force of the coil spring 55. Then, the pressure of the ink accommodated in the concave portion 54 increases, and at the same time, the pressure of the ink in the introducing passage 56 connected to the concave portion 54 also increases. As a result, as illustrated in FIG. 7B, the ink surface at the opening 56a of the supplying needle 23 has a convex shape. At the same time, the tip of the supplying needle 23 comes in contact with the supplying valve 47.

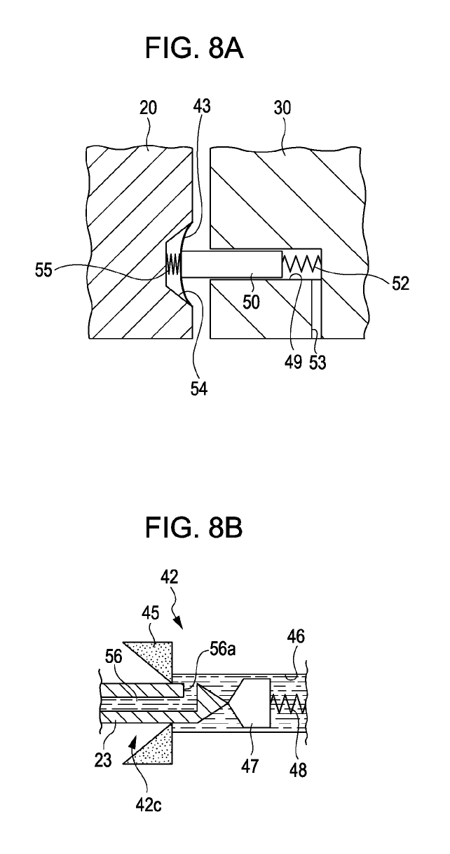

Next, as illustrated in FIG. 8A, when the cartridge 30 is further pushed to reach the mounting position in the accommodating part 15, as the biasing force of the coil spring 55 toward the film member 43 and the biasing force of the coil spring 52 and the air pressure in the concave portion 49 toward the sliding member 50 maintain a balanced state, the sliding member 50 deforms the film member 43 to be additionally bent in a direction to decrease the volume in the concave portion 54, against the biasing force of the coil spring 55.

In addition, at the same time, as illustrated in FIG. 8B, the tip of the supplying needle 23 is inserted into the valve chamber 46 through the opening of the seal member 45. Then, the ink in the pouch 41 is caused to flow into the introducing passage 56 through the opening 56a formed at the tip of the supplying needle 23 and passes through the supplying passage 57 in the holder main body 20a and the supplying passage 18 connected to the supplying passage 57 to be supplied to the sub tank of the print head 14. In addition, the valve chamber 46 is sealed as the outer peripheral surface of the supplying needle 23 comes in close contact with the periphery of the opening of the seal member 45. In the case where the supplying valve 47 is moved to an open valve position to be separated from the seal member 45, it is fitted through with a predetermined gap between its outer peripheral surface and the inner peripheral surface of the valve chamber 46, which functions as an ink passage. Therefore, when the supplying valve 47 is moved to the open valve position, the ink stored in the pouch 41 is caused to flow into the valve chamber 46 through the gap.

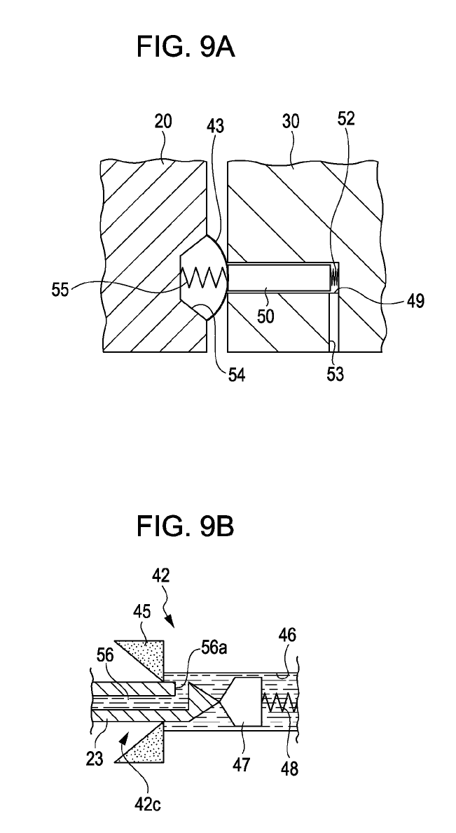

Thereafter, from the state illustrated in FIG. 8A, as air in the concave portion 49 is released slowly through the communication hole 53, the air pressure in the concave portion 49 is decreased to reach a value equal to the atmospheric pressure, and at the same time, the biasing force of the air pressure in the concave portion 49 toward the sliding member 50 is decreased to reach a negligible value. Here, since the elastic force of the coil spring 52 for biasing the sliding member 50 is set to be smaller than the elastic force of the coil spring 55 for biasing the film member 43, the film member 43 is biased by the coil spring 55 to be bent in the direction (that is, outward) to increase the volume in the concave portion 54 so as to further push the sliding member 50 in an inward direction of the concave portion 49 against the biasing force of the coil spring 52. Then, at a time point when the film member 43 is bent towards the cartridge 30 until the biasing force of the coil spring 55 toward the film member 43 and the biasing force of the coil spring 52 toward the sliding member 50 are in a balanced state, the film member 43 is restored to the state before the cartridge 30 was mounted to the holder 20 (see FIG. 9A).

Simultaneously, the ink pressure in the concave portion 54 decreases with the increase in the volume, and the ink pressure in the introducing passage 56 connected to the concave portion 54 also decreases. Here, as illustrated in FIG. 9B, since the introducing passage 56 is connected to the pouch 41 through the valve chamber 46, ink is flown from the pouch 41 to compensate for the decrease in the ink pressure in the introducing passage 56. That is, since the introducing passage 56, the valve chamber 46, and the pouch 41 are connected while being filled with ink, even in the case where the ink pressure in the introducing passage 56 decreases, ink is supplied while air is not incorporated into the introducing passage 56.

The operations of the holder 20 upon mounting the cartridge 30 have been described above. Next, the operations of the holder 20 upon detaching the cartridge 30 will be described.

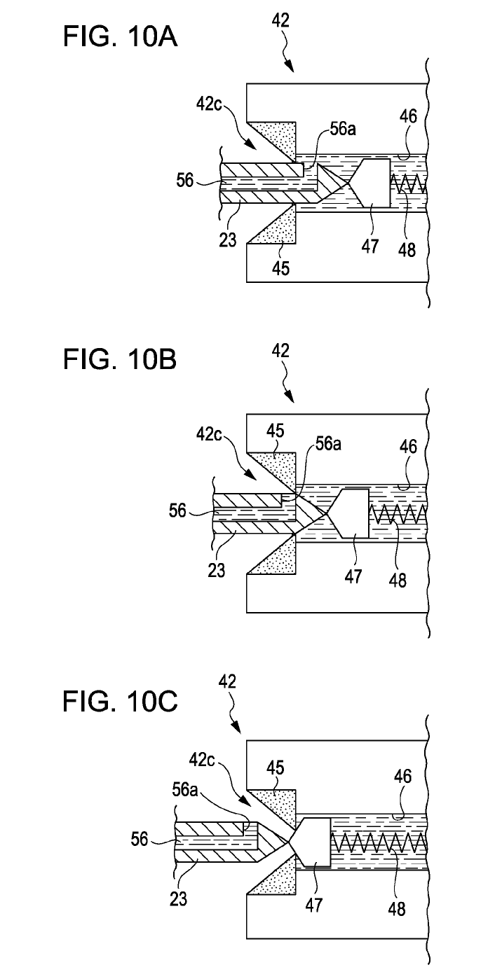

First, upon detaching the cartridge 30 from the holder 20, as illustrated in FIG. 10A, from the state where the tip of the supplying needle 23 is inserted through the supplying opening 42c and the inside of the introducing passage 56 is connected to the valve chamber 46 through the opening 56a, the cartridge 30 displaces in a direction away from the holder 20 to allow the inner periphery of the seal member 45 to slide toward the front end side of the supplying needle 23 while coming in close contact with the outer peripheral surface of the supplying needle 23 of the holder 20. Here, since the supplying valve 47 is biased by the coil spring 48 toward the supplying needle 23, it undergoes a displacement towards the seal member 45 while maintaining a close connection to the supplying needle 23.

In addition, when the inner periphery of the seal member 45 passes the opening 56a of the supplying needle 23, since the inner diameter of the opening of the seal member 45 and the outer diameter of the supplying needle 23 are substantially the same, the inner periphery of the seal member 45 slides on the outer peripheral surface of the supplying needle 23 to wipe the ink, and a flat ink surface is formed along the outer peripheral surface of the supplying needle 23 at the opening 56a of the supplying needle 23 (see FIG. 10B).

Moreover, when the tip of the supplying needle 23 is removed from the opening of the seal member 45, the supplying valve 47 is disposed at a position close to the seal member 45 since it maintains a close connection to the tip of the supplying needle 23. Accordingly, right after the supplying needle 23 is removed, the supplying valve 47 is biased by the coil spring 48 to come in pressing contact with the seal member 45. Therefore, upon removing the supplying needle 23, it is possible to restrict the leakage of ink from the cartridge 30 through the opening of the seal member 45.

In addition, upon detaching the cartridge 30, the film member 43 of the holder 20 is restored to the state (that is, a swollen shape) before the cartridge 30 was mounted to the holder 20. Accordingly, even through the pressing of the sliding member 50 to the film member 43 is released as the cartridge 30 is separated from the holder 20, there is no displacement of the film member 43. Therefore, the volume in the concave portion 54 sealed by the film member 43 is not changed, so that the pressure of the ink accommodated in the concave portion 54 becomes constant. In addition, since the ink pressure in the introducing passage 56 connected to the concave portion 54 also becomes constant, air does not move into the introducing passage 56 from the opening 56a of the supplying needle 23, and the flat ink surface at the opening 56a of the supplying needle 23 is maintained.

According to the embodiment, the following advantages can be obtained.

(1) In this embodiment, upon mounting the cartridge 30, the biasing force of the coil spring 52 and the air pressure in the concave portion 49 toward the sliding member 50 are set to be greater than the biasing force of the coil spring 55 toward the film member 43. Accordingly, the sliding member 50 can press the film member 43 against the biasing force of the coil spring 55 in the direction to decrease the volume in the concave portion 54 while coming in contact with the film member 43. Therefore, as the volume in the concave portion 54 is decreased, the ink pressure in the concave portion 54 is increased, so that the ink surface at the opening 56a of the supplying needle 23 connected to the concave portion 54 becomes convex. In addition, air between the ink surface at the opening 56a and the ink surface of the cartridge 30 is not trapped in that state, and it is possible to avoid the incorporation of bubbles of the air into the cartridge 30.

On the other hand, upon detaching the cartridge 30, the biasing force of the coil spring 52 toward the sliding member 50 is set to be smaller than the biasing force of the coil spring 55 toward the film member 43. Accordingly, the film member 43 can increase the volume in the concave portion 49 against the biasing force of the coil spring 52 while coming in contact with the sliding member 50. That is, at the time point when the cartridge 30 is detached and the opening 56a of the supplying needle 23 is exposed to the air, the film member 43 is restored to the state before the cartridge 30 was mounted. Accordingly, even though the pressing of the sliding member 50 to the film member 43 is released as the cartridge 30 is detached, the volume in the concave portion 54 increases and the ink pressure in the concave portion 54 decreases, so that the air does not move through the opening 56a of the supplying needle 23. Therefore, even in the case where the cartridge 30 is re-mounted after being detached, it is possible to avoid the incorporation of bubbles into the cartridge 30.

(2) In this embodiment, upon mounting the cartridge 30, the film member 43 presses the sliding member 50 against the biasing force of the coil spring 52. Here, the air included in the concave portion 49 is compressed by the sliding member 50 without leaking through the communicating hole 53 to increase the pressure, so that the air biases the sliding member 50 toward the film member 43 along with the coil spring 52. As a result, the sliding member 50 can press the film member 43 against the biasing force of the coil spring 55 in the direction to decrease the volume in the concave portion 54. In addition, when the mounting of the cartridge 30 is completed, the air included in the concave portion 49 by the sliding member 50 slowly leaks through the communication hole 53 such that the pressure gradually decreases. In addition, at a time point when the biasing force of the coil spring 52 and the air pressure in the concave portion 49 is lower than the biasing force of the coil spring 55, the film member 43 biased by the coil spring 55 presses the sliding member 50 against the biasing force of the coil spring 52 and the air pressure in the concave portion 49 is restored to the state before the mounting of the cartridge 30. Therefore, the configuration in which the magnitude relationship between the biasing forces toward the film member 43 and the sliding member 50 is changed according to the mounting and detaching of the cartridge 30 can be easily implemented.

### Second Embodiment

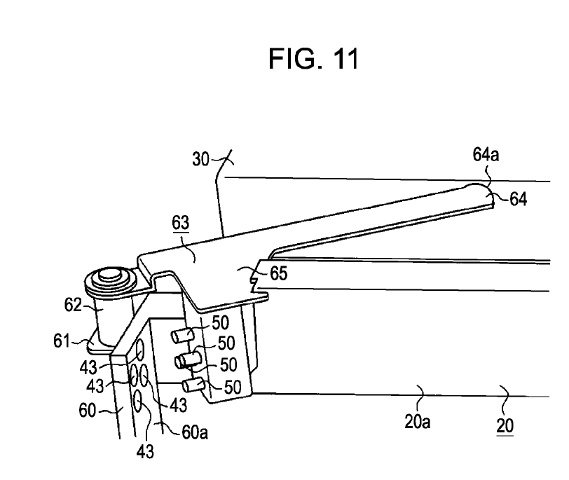

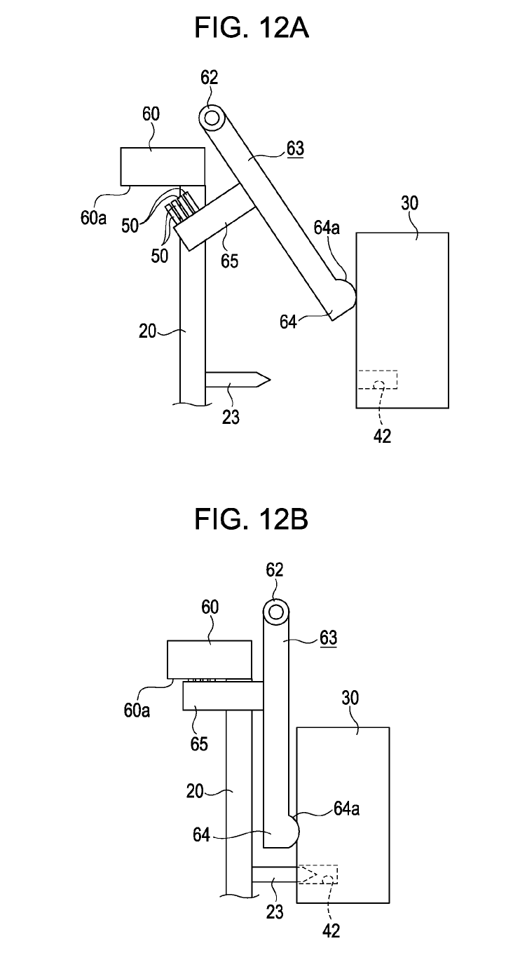

Next, a second embodiment of the invention will be described with reference to FIGS. 11 and 12. In addition, the configuration of the second embodiment is different from that of the first embodiment in the following point. That is, this embodiment is different from the first embodiment in that the sliding member 50 that presses the film member 43 is not provided in the cartridge 30 that is mounted to and detached from the printer 10, and a lever member is provided as a displacement member rotatably connected to the holder 20. Therefore, in the following description, like elements corresponding as in the first embodiment are denoted by like numerals, and any overlapping description will be omitted.

As illustrated in FIG. 11, the holder 20 in this embodiment has the holder main body 20a having a substantially rectangular plate shape, and a wall 60 is provided on one side in the longitudinal direction of the holder main body 20a to extend along the mounting direction of the cartridge 30. The wall 60 has an inner wall surface 60a contacting an inner side in the longitudinal direction of the holder main body 20a, and the plural (in this embodiment, four) film members 43 are provided on the inner wall surface 60a to block the openings of the concave portions 54 connected to the supplying passages 57 as in the first embodiment. In addition, a base part 61 extending outward from the longitudinal direction of the holder main body 20a is provided on the one side in the longitudinal direction of the holder main body 20a, and a supporting roller 62 having a substantially columnar shape extending in a lateral direction of the holder main body 20a is rotatably attached to the base part 61 by an axle.

One end of a lever member 63 in its longitudinal direction is rotatably supported by the supporting roller 62, and the other end thereof in the longitudinal direction has a substantially fan-shaped concave portion 64 with an arc surface 64a protruding towards the cartridge 30. In addition, an extending part 65 extending in a direction perpendicular to the longitudinal direction of the lever member 63 is provided to the lever member 63. The substantially columnar sliding members 50 protrude from the extending part 65 at positions opposed to the respective film members 43 provided on the inner wall surface 60a of the holder main body 20a in the rotation direction of the lever member 63. The lever member 63 is always biased by a coil spring (not shown) such that the sliding member 50 rotates in a direction away from the film member 43.

Next, the operations of the lever member 63 having the above-mentioned configuration will be described with reference to FIGS. 12A and 12B.

First, upon mounting the cartridge 30 to the holder 20 in this embodiment, as illustrated in FIG. 12A, the cartridge 30 is inserted toward the holder 20 to a position to come in contact with the convex portion 64 of the lever member 63. Next, in the case where the cartridge 30 is additionally inserted in the mounting direction (to the left in FIG. 12A), the lever member 63 rotates clockwise while drawing an arc track using the axis of the supplying roller 62 as the origin against the biasing force of the coil spring, as the front surface (the mounting surface) of the cartridge 30 slides on the arc surface 64a while coming in contact with the arc surface 64a of the convex portion 64 of the lever member 63. Then, after rotating to the position to come in contact with the film member 43 along with the lever member 63, the sliding member 50 presses the film member 43 in the direction to decrease the volume in the concave portion 54 sealed by the film member 43 (see FIG. 12B). Simultaneously, the supplying needle 23 of the holder 20 is intruded into the ink discharge opening forming member 42 of the cartridge 30 to discharge the ink stored in the cartridge 30. In addition, at a time point when the supplying needle 23 is intruded into the ink discharge opening forming member 42, the film member 43 is pressed by the sliding member 50 only by a predetermined degree, and the ink pressure in the concave portion 54 sealed by the film member 43 is increased. In addition, the ink pressure in the introducing passage 56 of the supplying needle 23 connected to the concave portion 54 is also increased, so that the ink surface at the opening 56a of the supplying needle 23 is convex. Therefore, upon mounting the cartridge 30, it is possible to suppress the incorporation of bubbles into the cartridge 30 through the supplying needle 23.

In addition, in the case where the cartridge 30 in the state of FIG. 12B is detached from the holder 20, the lever member 63 rotates counterclockwise while drawing an arc track using the axis of the supporting roller 62 as the origin by the biasing force of the coil spring, as the pressing of the cartridge 30 is released. Here, the volume in the concave portion 54 sealed by the film member 43 is already restored to the state before the cartridge 30 was mounted (see FIG. 12A). Accordingly, even though the pressing of the sliding member 50 toward the film member 43 is released as the sliding member 50 rotates in a direction away from the film member 43 along with the lever member 63, there is no additional displacement of the film member 43 in the direction to increase the volume in the concave portion 54.

Therefore, in this embodiment, in addition to the advantages (1) and (2) of the first embodiment, the following advantage can be obtained.

(3) In this embodiment, it is not necessary to provide the sliding member 50 in the cartridge 30, so that it is possible to increase the design freedom of the cartridge 30.

In addition, the embodiments may be modified into other embodiments described as follows.

In the embodiments, a configuration in which a pressure adjusting unit for adjusting the ink pressure in the introducing passage 56 is provided to adjust the ink pressure in the introducing passage 56 according to the mounting and detaching of the cartridge 30 may be employed.

In the embodiments, as the biasing member which comes in contact with the film member 43 for biasing, another type of biasing member such as a plate spring may be used.

In the embodiments, as the biasing member which comes in contact with the sliding member 50 for biasing, another type of biasing member such as a plate spring may be used.

In the embodiments, a configuration may be employed in which a pressure adjusting unit for adjusting the pressure in the concave portion 49 of the cartridge 30 is provided to control the time period for reducing the pressure in the concave portion 49 upon mounting the cartridge 30. Here, in the case where the pressure adjusting unit can reduce the pressure in the concave portion 49 to be lower than the atmospheric pressure, it is possible to set the elastic force of the coil spring 52 for pressing the sliding member 50 to be greater than the elastic force of the coil spring 55 for pressing the film member 43.

In the embodiments, a valve mechanism for preventing air in the concave portion 49 from being rapidly released and allowing the air in the concave portion 49 to be slowly discharged in the case where the air pressure in the concave portion 49 is increased may be provided in the communicating hole 53 for connecting the inside and the outside of the concave portion 49 of the cartridge 30.

In the embodiments, as the pressing member for pressing the film member 43 of the holder 20, a flexible film member for sealing the opening of the concave portion opposed to the film member 43 may be employed.

In the embodiments, an ink jet type printer and an ink cartridge are employed. However, a liquid ejection apparatus for ejecting or discharging liquids other than the ink and a liquid container containing such liquids may be employed. In addition, various types of liquid consumption apparatus having a liquid ejection head for discharging a small amount of liquid droplets or the like may be employed. Liquid droplets refer to a liquid state discharged from the liquid ejection apparatus, and may include grain-shaped and tear-shaped droplets and droplets leaving string-shaped traces. The liquid described herein may be any material that the liquid consumption apparatus can eject. For example, materials in a liquid state may be employed, and the materials include a flow state such as a liquid state having high or low viscosity, sol, gel water, inorganic solvents, organic solvents, solutions, liquid resin, liquid metal (metal melt), liquid in a primary material state, and those in which particles of functional material made of solids such as pigments and metal particles are dissolved in, distributed through, or mixed with a solvent. In addition, a representative example of the liquid may be the ink described above in the embodiment. Here, the inks may include various types of liquid composition such as general water-based ink and oil-based ink, gel ink, and hot melt ink. Examples of the liquid consumption apparatus may include liquid crystal displays, EL (electroluminescence) displays, surface-emitting displays, liquid ejection apparatuses for ejecting liquid in which an electrode material or a color material used for manufacturing a color filter or the like is distributed or dissolved, liquid ejection apparatuses for ejecting bio-organic materials used for manufacturing a bio chip, liquid ejection apparatuses for ejecting liquid used for a precision pipette as a sample, printing apparatuses, microdispensers, and the like. Additionally, liquid ejection apparatuses for ejecting lubricating oil at a pinpoint into a precision machine such as a watch or a camera, liquid ejection apparatuses for ejecting transparent resin liquid such as UV cured resin on a substrate to form a micro hemispherical lens (optical lens) used for an optical communication element and the like, and liquid ejection apparatuses for ejecting an acid or alkali etchant for performing etching on a substrate or the like, may be employed. In addition, the invention can be applied to any type of ejection apparatus and liquid container.

What is claimed is:

1. A liquid container mounting and detaching structure in which a liquid container containing liquid can be mounted and detached, and upon mounting the liquid container, a liquid discharge member having an opening at its tip is inserted through a liquid discharge opening provided in the liquid container to discharge the liquid, and the liquid discharged from the inside of the liquid container is caused to flow into a liquid passage connected to the liquid discharge member through the opening of the liquid discharge member, the liquid container mounting and detaching structure comprising:
a passage formation unit that constitutes at least a part of the walls in the liquid passage so as to be displaced in a direction to increase or decrease the volume in the liquid passage;
a first biasing mechanism that biases the passage formation unit in the direction to increase the volume in the liquid passage;
a pressing member that presses the passage formation unit in the direction to decrease the volume in the liquid passage against the biasing force of the first biasing mechanism upon mounting the liquid container; and
a second biasing mechanism that biases the pressing member in a pressing direction,
wherein the biasing force of the second biasing mechanism is set to be greater than the biasing force of the first biasing mechanism upon mounting the liquid container, and set to be smaller than the biasing force of the first biasing mechanism upon detaching the liquid container from the mounted state.

2. The liquid container mounting and detaching structure according to claim 1,
wherein the second biasing mechanism includes:
an air chamber that slidably supports the pressing member in the pressing direction in the state where the base end portion of the pressing member in the pressing direction is inserted, and of which the volume is changed as the pressing member is moved along the pressing direction;
a press-side elastic member that is provided in the air chamber and comes in contact with the base end portion of the pressing member in the pressing direction for biasing the pressing member in the pressing direction; and
an air throttle passage that is provided at a position deviating from the movement range of the pressing member in the air chamber to enable communication with the outside, and that allows the air to flow between the inside and the outside of the air chamber while the air flow is throttled as the volume in the air chamber is increased or decreased with the movement of the pressing member, and
wherein the air throttle passage restricts the air flow from the air chamber such that the sum of the biasing force of the press-side elastic member toward the pressing member and the biasing force of the air in the air chamber toward the pressing member is greater than the biasing force of the first biasing mechanism toward the passage formation unit upon mounting the liquid container, and allows the air flow from the air chamber such that the sum of the biasing force of the press-side elastic member toward the pressing member and the biasing force of the air in the air chamber toward the pressing member is smaller than the biasing force of the first biasing mechanism toward the passage formation unit when the mounting of the liquid container is completed.

3. The liquid container mounting and detaching structure according to claim 2,
wherein the first biasing mechanism includes a counter press-side elastic member that comes in contact with the passage formation unit from the inside of the liquid passage and biases the passage formation unit against the biasing force of the second biasing mechanism, in a direction to increase the volume in the liquid passage, which is the opposite direction to the pressing direction of the pressing member, and
the elastic force of the counter press-side elastic member is designed to be greater than the elastic force of the press-side elastic member.

4. The liquid container mounting and detaching structure according to claim 1, further comprising a displacement member that displaces while in contact with the liquid container,
wherein the pressing member is provided in the displacement member and displaces between a contact position and a separated position to and from the passage formation unit upon mounting and detaching the liquid container.

5. A liquid ejection apparatus comprising a liquid ejection head for ejecting liquid, and the liquid container mounting and detaching structure according to claim 1.

6. A liquid container which can be mounted to and detached from a liquid container holder that includes a liquid discharge member having an opening at its tip, a passage formation unit that constitutes at least a part of walls in the liquid passage connected to the liquid discharge member so as to be displaced in a direction to increase or decrease the volume in the liquid passage; and a first biasing mechanism for biasing the passage formation unit in the direction to increase the volume in the liquid passage, that contains liquid, and that has a liquid discharge opening through which the liquid discharge member is inserted to discharge the liquid upon mounting the liquid container to the liquid container holder, the liquid container comprising:
a pressing member that presses the passage formation unit in the direction to decrease the volume in the liquid passage against the biasing force of the first biasing mechanism upon mounting the liquid container to the liquid container holder; and
a second biasing mechanism that biases the pressing member in a pressing direction,
wherein the biasing force of the second biasing mechanism is set to be greater than the biasing force of the first biasing mechanism upon mounting the liquid container to the liquid container holder and set to be smaller than the biasing force of the first biasing mechanism upon detaching the liquid container from the state mounted to the liquid container holder.
